(19) United States
(12) Patent Application Publication
(10) Pub. No.: US 2023/0244947 A1
(43) Pub. Date: Aug. 3, 2023

(54) SYSTEMS AND METHODS FOR TIME SERIES FORECASTING

(71) Applicant: Salesforce, Inc., San Francisco, CA (US)

(72) Inventors: Gerald Woo, Singapore (SG); Chenghao Liu, Singapore (SG); Doyen Sahoo, Singapore (SG); Chu Hong Hoi, Singapore (SG)

(21) Appl. No.: 17/843,775

(22) Filed: Jun. 17, 2022

Related U.S. Application Data
(60) Provisional application No. 63/304,480, filed on Jan. 28, 2022.

(51) Int. Cl. G06N 3/08; G06Q 10/04

(52) U.S. Cl. CPC G06N 3/088; G06Q 10/04

(57) ABSTRACT

Embodiments described herein provide a method of forecasting time series data at future timestamps in a dynamic system. The method of forecasting time series data also includes receiving, via a data interface, a time series dataset. The method also includes determining, via a frequency attention layer, a seasonal representation based on a frequency domain analysis of the time series data. The method also includes determining, via an exponential attention layer, a growth representation based on the seasonal representation. The method also includes generating, via a decoder, a time series forecast based on the seasonal representation and the trend representation.

### CROSS REFERENCE(S)

The instant application is a nonprovisional of and claim priority under 35 U.S.C. 119 to U.S. provisional application No. 63/304,480, filed Jan. 28, 2022, which is hereby expressly incorporated by reference herein in its entirety.

### TECHNICAL FIELD

The embodiments relate generally to machine learning systems, and more specifically to time series forecasting.

### BACKGROUND

A time series is a set of values that correspond to a parameter of interest at different points in time. Examples of the parameter can include prices of stocks, temperature measurements, and the like. Time series forecasting is the process of determining a future datapoint or a set of future datapoints beyond the set of values in the time series. For example, a prediction of the stock prices into the next trading day is a time series forecast. Time series forecasting based on traditional transformer models can often be computationally costly, because pair-wise interaction is performed in the self-attention mechanism of the transformer model during dependencies detection in the time series. Furthermore, the self-attention mechanism in a transformer can often be prone to overfitting spurious patterns (e.g., noise of the time series data) when a priori knowledge of the time series is lacking.

### BRIEF DESCRIPTION OF THE DRAWINGS

FIG. 1 is a simplified diagram illustrating an example architecture of a multi-head exponential smoothing Transformer-based model (hereinafter “ETSformer”) for generating a time series forecast, according to one embodiment described herein.

FIG. 2 is a simplified diagram illustrating an example encoder layer of the ETSformer encoder shown in FIG. 1, according to one embodiment described herein.

FIG. 3 is a simplified diagram illustrating an example multi-head exponential smoothing attention module in the encoder layer shown in FIG. 2, according to one embodiment described herein.

FIG. 4 is a simplified diagram illustrating an example frequency attention module in the encoder layer shown in FIG. 2, according to one embodiment described herein.

FIG. 5 is a simplified diagram illustrating an example decoder layer of the ETSformer decoder shown in FIG. 1, according to one embodiment described herein.

FIG. 6 is a simplified data plot diagram illustrating example time series data in the lookback window and the forecasted data, according to one embodiment described herein.

FIG. 7 is a simplified diagram illustrating a computing device implementing the ETSformer for generating a time series forecast, according to one embodiment described herein.

FIG. 8 is an example logic flow diagram illustrating a method of generating a time series forecast based on the ETSformer shown in FIGS. 1-5, according to one embodiment described herein.

FIG. 9 is a simplified pseudocode segment illustrating an example operation of computing exponential smoothing attention, according to one embodiment described herein.

FIG. 10 is a simplified pseudocode segment illustrating an alternative operation of computing exponential smoothing attention via convolution, according to one embodiment described herein.

FIGS. 11-14 provide example performance from data experiments of the ETSformer of time series forecasting, according to one embodiment described herein. In the figures, elements having the same designations have the same or similar functions.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Time series forecasting based on traditional transformer models can often be computationally costly and inaccurate. In addition, fast adaptation capability of deep neural networks in non-stationary environments can be important for online time series forecasting. Successful solutions require handling changes to new and recurring patterns. However, training deep neural forecaster on the fly is often challenging because of the limited ability of the models to adapt to non-stationary environments and the catastrophic forgetting of old knowledge.

In view of the need for efficient and accurate time series forecasting, embodiments described herein provide a multi-head exponential smoothing Transformer-based (hereinafter “ETSformer”) forecasting model that adopts an exponential smoothing mechanism and a frequency attention mechanism to capture temporal characteristics and the growth characteristics of the time series data. Specifically, the ETSformer model having an encoder-decoder structure is configured to generate forecast data based on a latent seasonal component capturing temporal characteristics and a latent trend component capturing growth characteristics beyond the datapoints in the timeseries. The generated forecast data is thus adjusted for the temporal characteristics (seasonality) and growth characteristics of the timeseries.

In one embodiment, the ETSformer model has an encoder-decoder architecture that (a) leverages the stacking of multiple layers to progressively extract a series of level, growth, and seasonal representations from the intermediate latent residual; (b) based on exponential smoothing, extract the salient seasonal patterns while modeling level and growth components by assigning higher weight to recent observations; and (3) the final forecast is a composition of level, growth, and seasonal components.

Specifically, for forecasting time series data at future timestamps in a dynamic system, time series data within a lookback time window is received. A temporal convolutional filter may preprocess the time series data within the lookback time window into a latent space prior to feeding the time series data into an encoder.

In one embodiment, the encoder comprises a plurality of encoder layers, and at least one encoder layer comprises the frequency attention layer and the exponential smoothing attention layer. The encoder encodes the time series data into a level representation, a growth representation and a seasonal representation.

In one embodiment, during encoding, the frequency attention layer determines the seasonal representation by capturing a seasonal variation in a frequency domain representation of the time series data. For example, a first seasonal component is determined for a current encoder layer by applying frequency attention to a residual representation of a previous encoder layer and the residual representation is updated by subtracting the first seasonal component from the residual representation. The frequency attention is applied by decomposing the residual representation into Fourier bases via discrete-time Fourier transform (DFT) along a temporal dimension; and obtaining a seasonality pattern by applying an inverse DFT to a subset of the Fourier bases into a time domain.

In one embodiment, during encoding, the exponential smoothing attention layer determines the growth representation by exponentially smoothing the time series data. For example, a first growth component for the current encoder layer by applying multi-head exponential smoothing average to the updated residual representation within the lookback time window, and a residual representation of the current encoder layer is output based on the updated residual representation of the previous encoder layer and the first growth component. Specifically, multi-head exponential smoothing average may be efficiently applied by a construction of an exponential smoothing attention matrix, and iteratively shifting each row of the exponential attention matrix to the right while computing the exponential smoothing average via matrix multiplications.

Further, during encoding, the level representation is determined based on a smoothing average applied to the determined growth representation, the determined seasonal representation, and a previous level presentation at a previous time. For example, a weighted average of a current level representation and a level-growth forecast from a previous time step is computed. The current level representation is computed based on a level representation from a previous encoder layer and the first seasonal component, and the level-growth forecast is computed based on a level representation from the previous time step and a growth representation from the previous time step.

In one embodiment, a decoder then generates a plurality of forecast datapoints corresponding to a future time window based on the level representation, the growth representation and the seasonal representation. For example, the decoder comprises a plurality of decoder layers, and at least one decoder layer comprises a decoder frequency attention layer and a growth damping layer. The plurality of forecast datapoints corresponding to the future time window are generated by receiving, at one decoder layer, a first seasonal component and a first growth component from an encoder layer, generating, by the growth damping layer, a growth forecast component for the future time window based on the first growth component, and generating, by the decoder frequency attention layer, a seasonal forecast component for the future time window based on the first seasonal component.

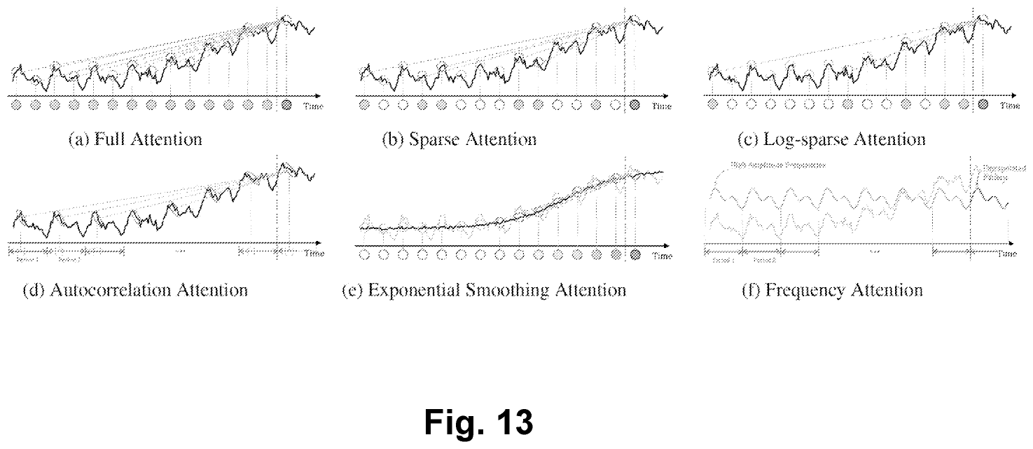

In this way, the ETSformer model may be used for time series forecasting based on an exponential attention smoothing algorithm that reduces computational processing overhead. Specifically, the ETSformer models may be implemented on parallel processors to improve computational efficiency. For example, the exponential attention smoothing algorithm can be efficiently implemented via the algorithm as described in FIG. 10. Therefore, the ETSformer model may be implemented with improved computational efficiency, which facilitates hardware implementation of the models with much less demanding fewer computational resources such as processors, memory and the like.

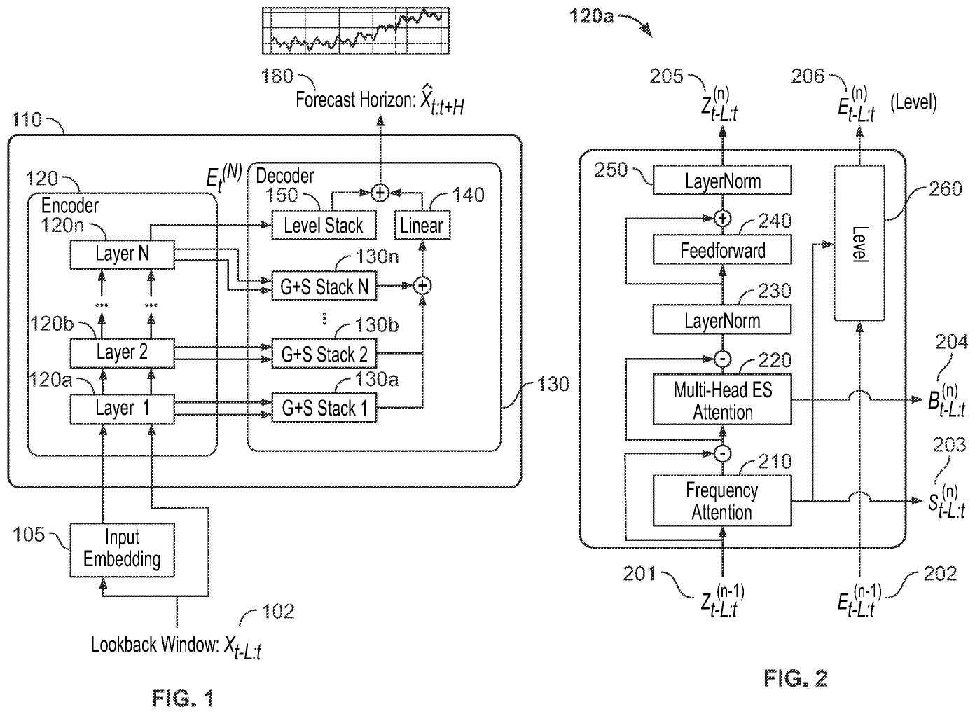

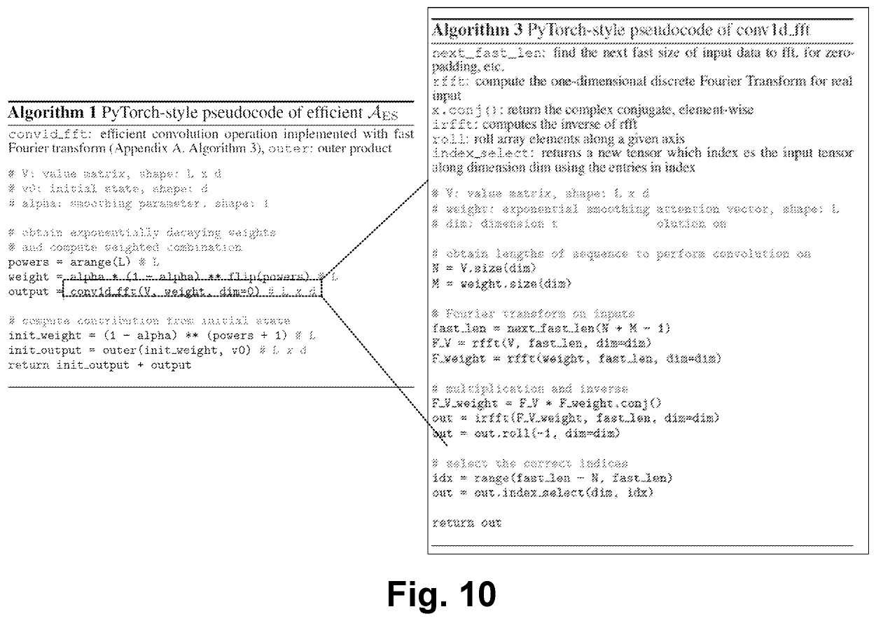

FIG. 1 is a simplified diagram illustrating an example of an architecture of a ETSformer model for generating a time series forecast. The ETSformer model 110 may include an encoder 120 and a decoder 130 that forms an encoder-decoder architecture. In some embodiments, the ETSformer model 110 may be implemented as software, as part of a hardware or a combination of software and hardware. For example, the ETSformer model 110 may be executed on a plurality of processors (e.g., 710), from a memory (e.g., 720) as described below with respect to FIG. 7. In some embodiments, the ETSformer model 110 comprises a temporal convolution transformer model.

The ETSformer model 110 may receive an input 102 such as time series data via an input interface or from a memory location. The received input 102, denoted by X_{t-L:t}=[x_{t-L}, . . . , xₜ₋₁], may include time series data within a lookback window t-L to t. In one embodiment, the ETSformer model 110 may generate an output of time series forecast 180, such as H-step ahead forecast future values over a horizon X_{t:t+H}=[xₜ, . . . , x_{t+H-1}], in the future time window t to t+H. The point forecast 180 of the future values is denoted by \hat{X}_{t:t+H}.

In some embodiments, the input 102 may be preprocessed at an input encoding module 105, which may convert the input 102 to an input encoding. Specifically, the input embedding module 105 maps the raw time series input data 102 within the lookback window to a latent space, denoted by Z_{t-L:t}⁽⁰⁾=E_{t-L:t}⁽⁰⁾=Conv (X_{t-L:t}), where Conv ( ) is a temporal convolutional filter with kernel size 3, input channel m and output channel d. The input encoding from the input embedding module 105 together with the input data 102 are then sent to the encoder 120.

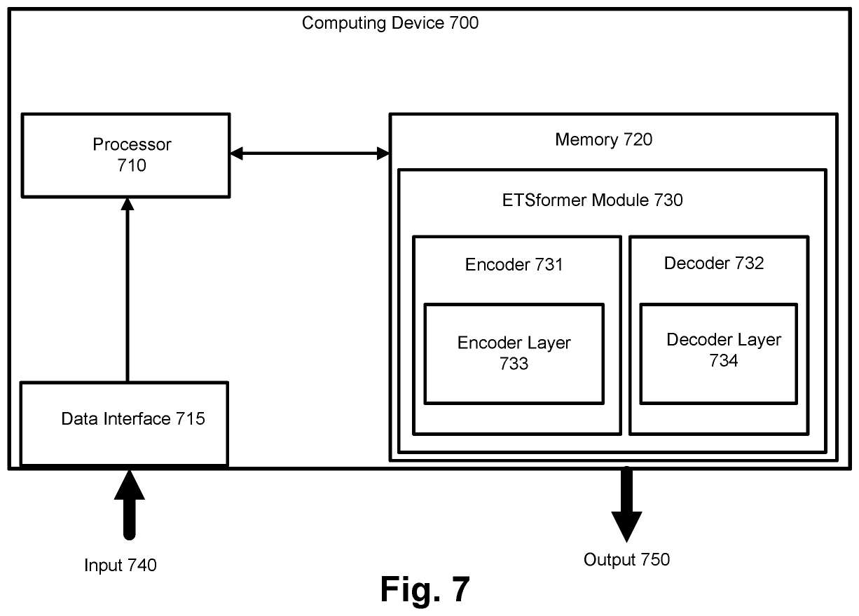

In some embodiments, the ETSformer model 110 may be independent of any other manually designed dynamic time-dependent covariates (e.g., month of the year, day of the week) for both the lookback window and forecast horizon. For example, the ETSformer model 110 may include a Frequency Attention layer as described in FIG. 4 below that may automatically uncover these seasonal patterns, which renders it more applicable for challenging scenarios without discriminative covariates.

In some embodiments, the encoder 120 may include one or more layers 120a-n. The one or more encoder layers 120a-n may encode the time series input data 102 into a seasonal representation, and a growth representation by iteratively extract growth and seasonal latent components from the input encoding and the input data 102. In some embodiments, the encoder 120 may sequentially extract the seasonal latent representation from the time series data and the latent growth component based on the seasonal latent representation.

In one embodiment, the encoder 120 may adopt an exponential smoothing mechanism to decompose the time series forecasting into a seasonal and growth representation. In some embodiments, the ETSformer model 110 may decompose the seasonal component into a level representation. For example, at each encoder layer 120a-n, the encoder layer may iteratively extract growth and seasonal latent components from the lookback window of the input data 102. The level component can then be extracted according to a smoothing equation:

eₜ=α(xₜ−sₜ₋ₚ)+(1−α)(eₜ₋₁+bₜ₋₁) Level:

bₜ=β(eₜ−eₜ₋₁)+(1−β)bₜ₋₁ Growth:

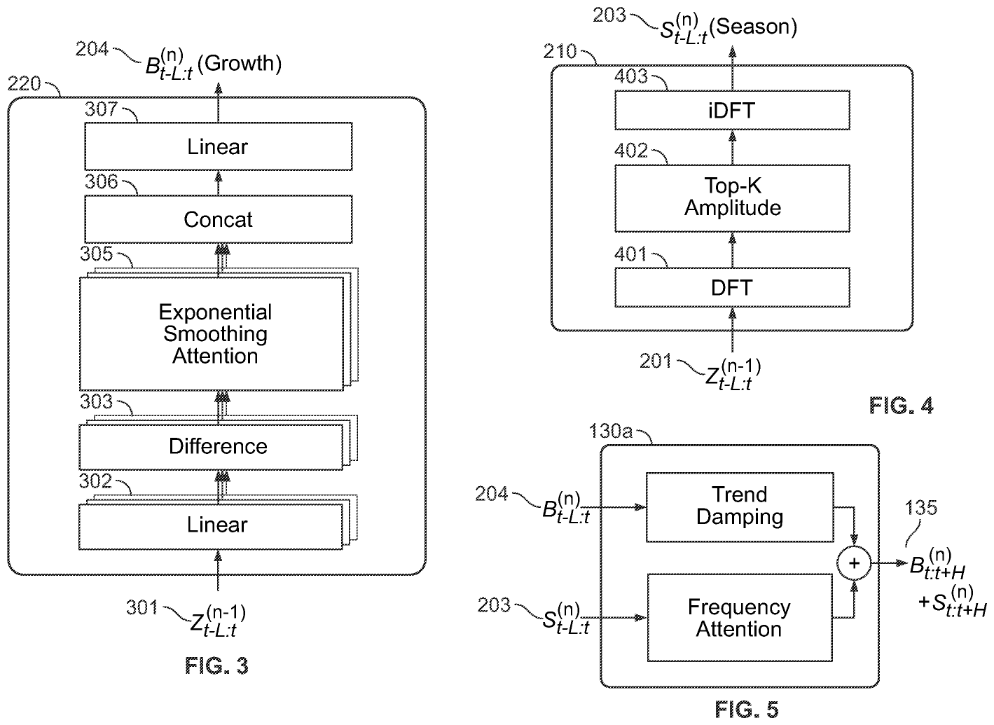

sₜ=γ(xₜ−eₜ)+(1−γ)sₜ₋ₚ Seasonal:

where p is the period of seasonality. Further details of the structure and operations of an encoder layer 120a may be described in relation to FIG. 2.

The decoder 130 of the ETSformer model 110 may include one or more G(rowth)+S(easonal) Stack layers 130a-130n. Specifically, each G+S decoder layer 130a-n may receive, from a corresponding encoder layer 120a-n in the encoder 120, a corresponding growth component and a corresponding seasonal component output from the corresponding encoder layer. The decoder 130 may further comprise a level stack layer 150, which receives a levels representation generated at the last encoder layer 120n in the encoder 120. The level representation represents a level of the look back window, of the input 102. In some embodiments, the decoder 130 may determine the h-steps ahead forecast based on the last estimated level eₜ and the last available seasonal factor sₜ₊ₕ₋ₚ,

x_{t+h|t}=eₜ+hbₜ+sₜ₊ₕ₋ₚ forecasting:

where x_{t+h|t} is the h-steps ahead forecast. Or, in some embodiments, the decoder 130 may determine h times the last growth factor, bₜ to forecast h steps ahead.

In some embodiments, the decoder 130 may determine the level smoothing equation based on a weighted average of the seasonally adjusted observation (xₜ−sₜ₋ₚ) and the non-seasonal forecast, obtained by summing the previous level and growth (eₜ₋₁+bₜ₋₁). The decoder 130 may determine growth smoothing based on a weighted average between the successive difference of the (de-seasonalized) level, (eₜ−eₜ₋₁), and the previous growth, bₜ₋₁. Finally, the decoder 130 may determine a seasonal smoothing based on a weighted average between the difference of observation and (de-seasonalized) level, (xₜ−eₜ), and the previous seasonal index sₜ₋ₚ. In an example, the decoder 130 may determine a weighted average of the level, growth and seasonal components which may vary based on based the smoothing parameters α, β and 9γ, respectively.

In some embodiments, the decoder 130 may adopt a damping parameter ϕ of the growth representation to produce a more robust multi-step forecast:

\hat{x}_{t+h|t}=eₜ+(ϕ+φ²+ . . . +φ^{h})bₜ+sₜ₊ₕ₋ₚ,

where the growth is damped by a factor of ϕ. If ϕ=1, it degenerates to the vanilla forecast. For 0<ϕ<1, as h→∞ this growth component approaches an asymptote given by bₜ/(1−ϕ).

In some embodiments, as shown in FIG. 1, the decoder 130 may use the level representation generated from the last encoder layer 130n and add it to the sum of all outputs from G+S decoder layers 130a-n after linear projection 140. The decoder 130 may then generate the time series forecast 180 in the forecast horizon based on the representation:

$${\hat{X}}_{t : t + H} = {E}_{t : t + H} + Linear ( {\sum }_{n = 1}^{N} ( {B}_{t : t + H}^{( n )} + {S}_{t : t + H}^{( n )} ) ) ,$$

where E_{t:t+H}∈ [symbol] ^{H×m}, and B_{t:t+H}⁽ⁿ⁾, S_{t:t+H}⁽ⁿ⁾∈ [symbol] ^{H×d} represent the level forecasts, and the growth and seasonal latent representations of each time step in the forecast horizon, respectively. The superscript represents the stack index, for a total of N encoder stacks. In an embodiment, the Linear (⋅): [symbol] ^{d}→ [symbol] ^{m} operates element-wise along each time step, projecting the extracted growth and seasonal representations from latent to observation space. Further details of the structure and operations of a G+S decoder layer 130a may be described in relation to FIG. 1.

FIG. 2 is a simplified diagram illustrating an example encoder layer of the Transformer encoder shown in FIG. 1, according to one embodiment described herein. An exemplary encoder layer 120a may include a frequency attention layer 210, a multi-headed exponential smoothing attention (MH-ESA) layer 220 followed by a normalized layer 230, a feedforward layer 240 followed by another normalization layer 250, and a levels layer 260.

In some embodiments, the encoder layer 120a may interpret the input signal 102 sequentially. The encoder layer 120a may remove the extracted growth representation and the seasonal representation from the residual representation. The encoder layer 120a may perform a non-linear transformation before moving to the next layer. For example, the encoder layer 120a may receive as input the residual 201 Z_{t-L:t}⁽ⁿ⁻¹⁾ from the previous encoder layer and emits the residual 205 Z_{t-L:t}⁽ⁿ⁾, latent growth 204 B_{t-L:t}⁽ⁿ⁾, and seasonal representations 203 S_{t-L:t}⁽ⁿ⁾ for the lookback window via the MH-ESA layer 220.

In some embodiments, the multi-headed attention layer 220 and the feed forward layer 240 may be connected via a normalization layer 230. The encoder layer 120a may generate the seasonal representation 205 via a second normalization layer 250 based on the output of the feedforward layer.

The encoder layer 120a may process the input residual 201 and an input level 202 based on the following equations:

s_{t-L:t}=FA_{t-L:t}(Z_{t-L:t}⁽ⁿ⁻¹⁾)

Z_{t-L:t}⁽ⁿ⁻¹⁾:=Z_{t-L:t}⁽ⁿ⁻¹⁾−S_{t-L:t}⁽ⁿ⁾ Seasonal:

B_{t-L:t}⁽ⁿ⁾=MH-ESA(Z_{t-L:t}⁽ⁿ⁻¹⁾)

Z_{t-L:t}⁽ⁿ⁻¹⁾:=LN(Z_{t-L:t}⁽ⁿ⁻¹⁾−B_{t-L:t}⁽ⁿ⁾)

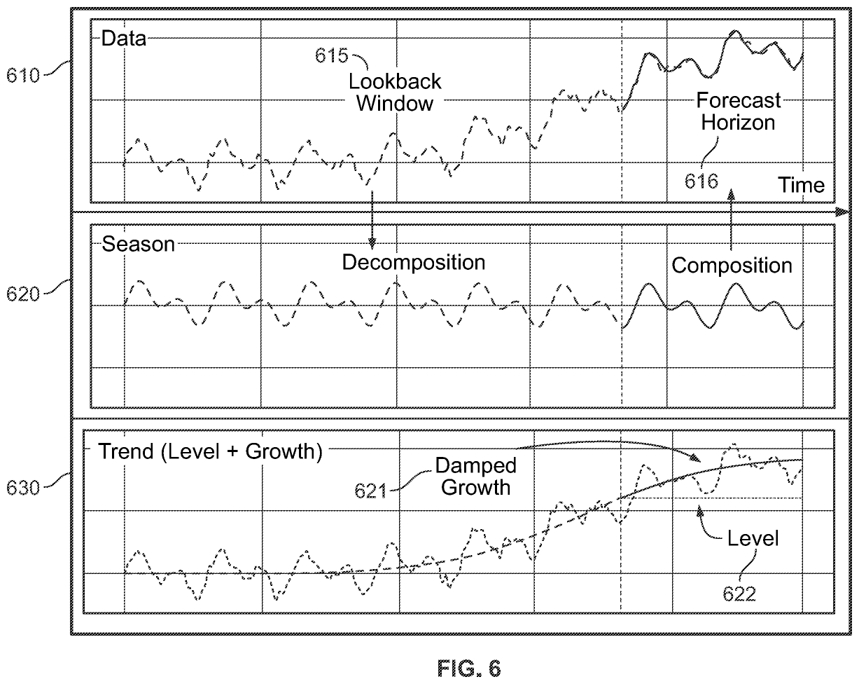

Z_{t-L:t}⁽ⁿ⁾=LN(Z_{t-L:t}⁽ⁿ⁻¹⁾+FF(Z_{t-L:t}⁽ⁿ⁻¹⁾)) Growth:

where, LN may be a layer normalization Linear (σ(Linear (x))) may be a position-wise feedforward network and σ(⋅) may be the sigmoid function; and MH-ESA ( ) denotes the transformation at the MH-ESA layer 220, which is further described in relation to FIG. 3.

The levels layer 260 may extract the level at each time step t in the lookback window via a level smoothing equation based on the latent growth and seasonal representations from each layer. The levels layer 260 may determine an adjusted level 206 based on the current de-seasonalized level and the level-growth forecast from the previous time t−1. In some embodiments, the adjusted level 206 may be a weighted average that may be represented as:

Eₜ⁽ⁿ⁾=α*(Eₜ⁽ⁿ⁻¹⁾−Linear(sₜ⁽ⁿ⁾))+(1−α)*(Eₜ₋₁⁽ⁿ⁾+Linear(Bₜ₋₁⁽ⁿ⁾))

where α∈ [symbol] ^{m} is a learnable smoothing parameter, * is an element-wise multiplication term, and Linear (⋅): [symbol] ^{d}→ [symbol] ^{m} maps representations to data space. In some embodiments, the extracted level in the last layer E_{t-L:t}^{(N)} such as the input to the level stock 150 (in FIG. 1) may be the corresponding level for the lookback window. In some embodiments, the recurrent exponential smoothing equation can also be efficiently evaluated using the efficient [symbol] _{ES} algorithm with an auxiliary term.

FIG. 3 is a simplified diagram illustrating an example multi-head exponential smoothing attention (MH-ESA) 220 layer in the encoder layer shown in FIG. 2, according to one embodiment described herein. The MH-ESA layer 220 may include a linear layer 302, a difference layer 303, an exponential smoothing layer 305, a concatenation layer 306 and a linear layer 307.

In some embodiments, the exponential smoothing attention layer 220 may receive an input 301, which is a seasonal representation output from a frequency attention layer (described in detail below with reference to FIG. 4). In an example, the linear layer 302 may transform the input features into output features using a weight matrix using matrix multiplication. For example, the input features received by a linear layer are passed in the form of a flattened one-dimension tensor and then multiplied by the weight matrix. The difference layer 303 may return a difference of the two inputs such as a tensor in response to two tensors. In some embodiments, the exponential smoothing layer 305 may extract the latent growth representation from a seasonal representation.

In some embodiments, the MH-ESA layer 220 may include multiple heads or multiple threads that run on a plurality of processors (e.g., CPU/GPU.) For example, the linear layer 302, the difference layer 303, and the exponential smoothing layer 305 may be executed as parallel processes, and the result may be concatenated at layer 306. For example, the concatenation layer 306 may receive as input a list of tensors, all of the same shape except for the concatenation axis, and returns a single tensor that is the concatenation of all inputs. The linear layer 307 may transform the input features using a weight matrix to determine the latent growth representation 204.

In some embodiments, the exponential smoothing attention layer 305 may extract the latent growth representation from a seasonal representation. In an embodiment, the exponential smoothing attention layer 305 maybe a non-adaptive, learnable attention scheme with an inductive bias to attend more strongly to recent observations by following an exponential decay. In some embodiments, the exponential smoothing attention layer 305 may be designed with an inductive bias to attend less strongly to recent observations.

In some embodiments, a vanilla attention smoothing attention layer may be a weighted combination of an input sequence, where the weights are normalized alignment scores measuring the similarity between inputs. In some embodiments, the exponential smoothing attention layer 305 may assign a different weight (e.g., a higher weight to recent observations, a lower weight to recent observations, a higher weight to earlier observations, a lower weight to earlier observations) to observations based on the time of the time series data. In some embodiments, the exponential smoothing attention layer 305 may be a weighted average with weights which decrease exponentially looking back further in the sequence. The exponential smoothing attention layer 305 may be a non-adaptive (i.e., weights are not obtained from query-key interactions) form of attention whose weights are learned via gradient descent. In some embodiments, the exponential smoothing attention layer 305 mechanism may not rely on pairwise query-key interactions to determine the attention weights, because it may be a function of the value matrix V. In some embodiments, the exponential smoothing attention layer 220 may be defined as [symbol] _{ES}: [symbol] ^{L×d}→ [symbol] ^{L×d}, where [symbol] _{ES}(V)ₜ∈ [symbol] ^{d} denotes the t-th row of the output matrix, representing the token corresponding to t-th time step. In some embodiments, the exponential smoothing formula can be further written as:

[symbol]

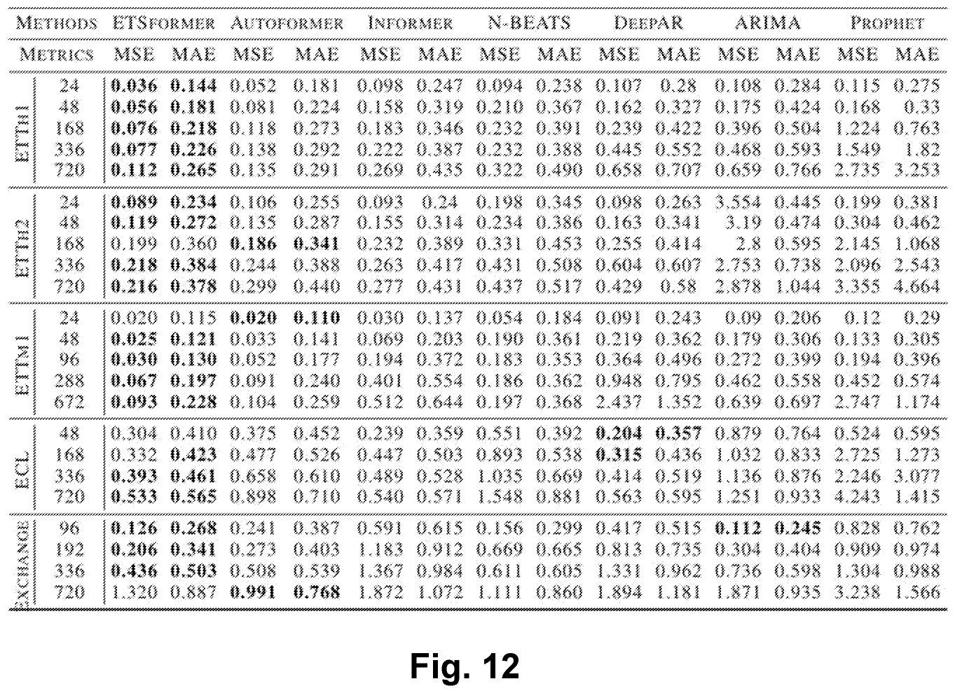

_{ES}(V)ₜ=αVₜ+(1−α) [symbol] _{ES}(V)ₜ₋₁=Σⱼ₌₀^{t-1}α(1−α)^{j}Vₜ₋ⱼ+(1−α)^{t}v₀,

where 0<α<1 and v₀ are learnable parameters known as the smoothing parameter and initial state respectively. Similar to the damping parameter ϕ, α is constrained by the sigmoid function. Additional details of computing the attention matrix shown above is described in relation to FIG. 9.

In one embodiment, the exponential smoothing attention layer 305 may adopt an efficient ESA algorithm of O (L log L) complexity due to the special construction of the attention matrix [symbol] _{ES}, whereas the simple matrix multiplication with the input sequence results in [symbol] (L²) complexity. Here L denotes the dimension of the attention matrix. For example, the attention matrix [symbol] _{ES} may be constructed as:

$${ES}_{} ( V ) = [ \begin{matrix}{ES}_{} {( V )}_{1} & \\ ⋮ & \\ & {ES}_{} {( V )}_{L}\end{matrix} ] = {A}_{ES} \cdot [ \begin{matrix}{v}_{0}^{T} \\ V\end{matrix} ] , \\ {A}_{ES} = [ \begin{matrix}{( 1 - α )}^{1} & α & 0 & 0 & … & 0 \\ {( 1 - α )}^{2} & α ( 1 - 6 ) & α & 0 & … & 0 \\ {( 1 - α )}^{3} & {α ( 1 - α )}^{2} & α ( - α ) & α & … & 0 \\ ⋮ & ⋮ & ⋮ & ⋮ & ⋱ & ⋮ \\ {( 1 - α )}^{L} & {α ( 1 - α )}^{L - 1} & … & {α ( 1 - α )}^{j} & … & α\end{matrix} ] .$$

In this way, the unique structure of the attention matrix A_{ES} can be used to reduce the computational complexity. For example, the exponential smoothing attention layer 220 may first ignore the initial state v₀ and its associated attention weights, in which way the attention matrix is one in which each row is iteratively right shifted with zero padding on the right-hand side of the first term—in other words, the matrix-vector multiplication involved in computing the attention matrix can be computed with a cross-correlation operation, which can be efficiently implemented via the fast Fourier transform. Additional details of efficient ESA algorithm for computing the attention matrix is described in relation to FIG. 10, achieving a complexity of O(L log L).

Therefore, the MH-ESA layer 220 may build upon the ESA layer 305 and develop the MH_ESA mechanism to extract latent growth representations. For example, the growth representations may be obtained by taking the successive difference of the residuals:

\tilde{Z}_{t-L:t}⁽ⁿ⁾=Linear(Z_{t-L:t}⁽ⁿ⁻¹⁾),

B_{t-L:t}⁽ⁿ⁾=MH−A_{ES}(\tilde{Z}_{t-L:t}⁽ⁿ⁾−[\tilde{Z}_{t-L:t-1}⁽ⁿ⁾,v₀⁽ⁿ⁾]),

B_{t-L:t}⁽ⁿ⁾:=Linear(B_{t-L:t}⁽ⁿ⁾),

where MH− [symbol] _{ES}( ) is a multi-head version of [symbol] _{ES} and v₀⁽ⁿ⁾ is the initial state from the ESA mechanism.

FIG. 4 is a simplified diagram illustrating an example frequency attention module 210 in the encoder layer 120a shown in FIG. 2, according to one embodiment described herein.

The frequency attention layer 210 may identify and extract seasonal patterns. In some embodiments, the frequency attention layer 210 may extract the seasonal patterns from the lookback. The frequency attention layer 210 may de-seasonalize the input signals such that downstream components may model the level and growth information. The frequency attention layer 210 may extrapolate the seasonal patterns to build representations for the forecast horizon. The frequency attention layer 210 may identify seasonal patterns without pre-specification of information such as the number or period of seasons.

The frequency attention layer 210 may determine a Frequency Attention (FA) mechanism to extract the dominant seasonal patterns based on discrete Fourier transformation. For example, the frequency attention layer 210 may determine the dominant seasonal patterns via attending the bases with the K-largest amplitudes in the frequency domain. The frequency attention layer 210 may include a discrete Fourier transformation layer 401, top-k amplitude layer 402 and an inverse discrete Fourier transformation layer 403.

In some examples, the discrete Fourier Transformation layer 401 may decomposes input signals 210 into their Fourier bases via a DFT along the temporal dimension, [symbol] (Z_{t-L:t}⁽ⁿ⁻¹⁾)∈ [symbol] ^{F×d} where F=[L/2]+1, and the Top-K Amplitude layer 402 selects bases with the K largest amplitudes. The inverse Discrete Fourier transformation layer 403 may determine the seasonality pattern in time domain. Formally, the steps of decomposing the input data 201 is given by the following equations:

$${Φ}_{k , i} = ϕ ( {( {Z}_{t - L : t}^{( n - 1 )} )}_{k , i} ) \\ {A}_{k , i} = \vert {( {Z}_{t - L : t}^{( n - 1 )} )}_{k , i} \vert \\ {κ}_{i}^{( 1 )} , … , {κ}_{i}^{( K )} = arg {Top}_{k ∈ \{ 2 , … , F \}} - K \{ {A}_{k , i} \} \\ {S}_{j , i}^{( n )} = {\sum }_{k = 1}^{K} {A}_{{κ}_{i}^{( k )} , i} [ cos ( 2 π {f}_{{κ}_{i}^{( k )}} j + {Φ}_{{κ}_{i}^{( k )} , i} ) + cos ( 2 π {\overline{f}}_{{κ}_{i}^{( k )}} j + {Φ}_{{κ}_{i}^{( k )} , i} ) ]$$

where Φ_{k,i}, A_{k,i} are the phase/amplitude of the k-th frequency for the i-th dimension, arg Top-K returns the arguments of the top K amplitudes, K is a hyperparameter, fₖ is the Fourier frequency of the corresponding index, and f̅ₖ, Φ̅_{k,i} are the Fourier frequency/amplitude of the corresponding conjugates. Finally, the latent seasonal representation of the i-th dimension for the lookback window is formulated as S_{t-L:t,i}^{(n)=[S}_{t-L,i}⁽ⁿ⁾, . . . , S_{t-1,i}⁽ⁿ⁾], while for the forecast horizon, S_{t:t+H,i}⁽ⁿ⁾+[S_{t,i}⁽ⁿ⁾, . . . , S_{t+H-1,i}⁽ⁿ⁾].

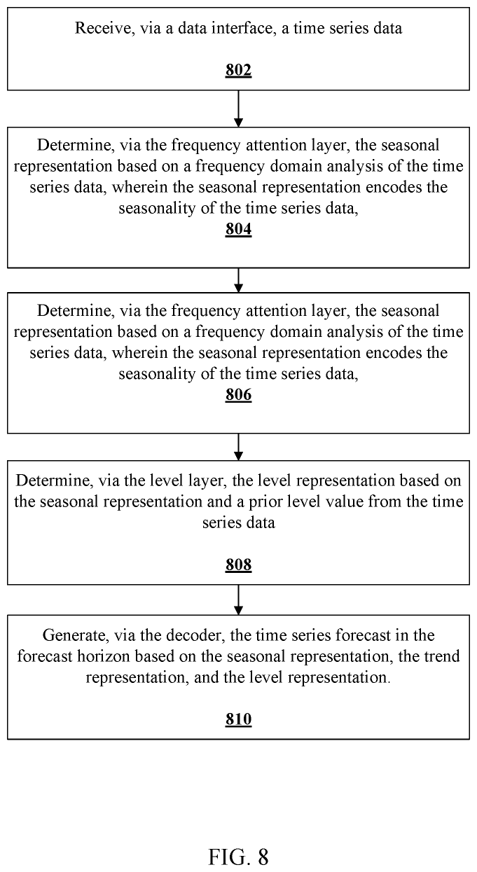

FIG. 5 is a simplified diagram illustrating an example decoder layer 130a of the Transformer decoder shown in FIG. 1, according to one embodiment described herein. The decoder 130 is tasked to generate H-step ahead forecasts. The decoder 130 may determine the final forecast based on a composition of level forecasts E_{t:t+H}, growth representations B_{t:t+H}⁽ⁿ⁾ and seasonal representations S_{t·t+H}⁽ⁿ⁾ in the forecast horizon.

The decoder layer 130a may include a Trend Damping (TD) layer that receives as input the growth representation 204 and FA layer that receives as input the seasonal representation 203. The decoder layer 130a may predict the sum of B_{t·t+H}⁽ⁿ⁾, S_{t:t+H}⁽ⁿ⁾, based on the growth representation 204 and the seasonal representation 203 such as B_{t-L·t}⁽ⁿ⁾, S_{t-L·t}⁽ⁿ⁻¹⁾ respectively. The decoder layer 130a may predict based on the following representation:

B_{t:t+H}⁽ⁿ⁾=TD(B_{t-L:t}⁽ⁿ⁾) Growth:

S_{t:t+H}⁽ⁿ⁾=FA_{t:t+H}(S_{t-L:t}⁽ⁿ⁾) Seasonal:

The decoder layer 130a may obtain the level in the forecast horizon, based on the level in the last time step t along the forecast horizon. The decoder layer 130a may repeat the level in the last time step t along the forecast horizon. The decoder layer 130 may determine the repetition based on the representation: E_{t:t+H}=Repeat_{H}(Eₜ^{(N)}), with Repeat_{H}(⋅): [symbol] ^{1×m}→ [symbol] ^{H×m}.

The decoder layer 130a may determine the growth representation in the forecast horizon based on trend dampening to make a multi-step forecast. In some embodiments, the decoder layer 130a may represent the trend representations as:

$${TD ( {B}_{t}^{( n )} )}_{j} = {\sum }_{i = 1}^{j} {γ}^{i} {B}_{t}^{( n )} \\ TD ( {B}_{t - L : t}^{( n )} ) = [ {TD ( {B}_{t}^{( n )} )}_{t} , … , {TD ( {B}_{t}^{( n )} )}_{t + H - 1} ]$$

where 0<γ<1 is the damping parameter, which is learnable, and in one implementation, a multi-head version of trend damping is applied by making use of nₕ damping parameter. Similar to the implementation in the level forecast, in some embodiments the decoder layer 130a may use the last trend representation in the lookback window Bₜ⁽ⁿ⁾ to forecast the trend representation in the forecast horizon. In an example, γ may be a free parameter and may be constrained by considering σ(γ) to be the damping parameter.

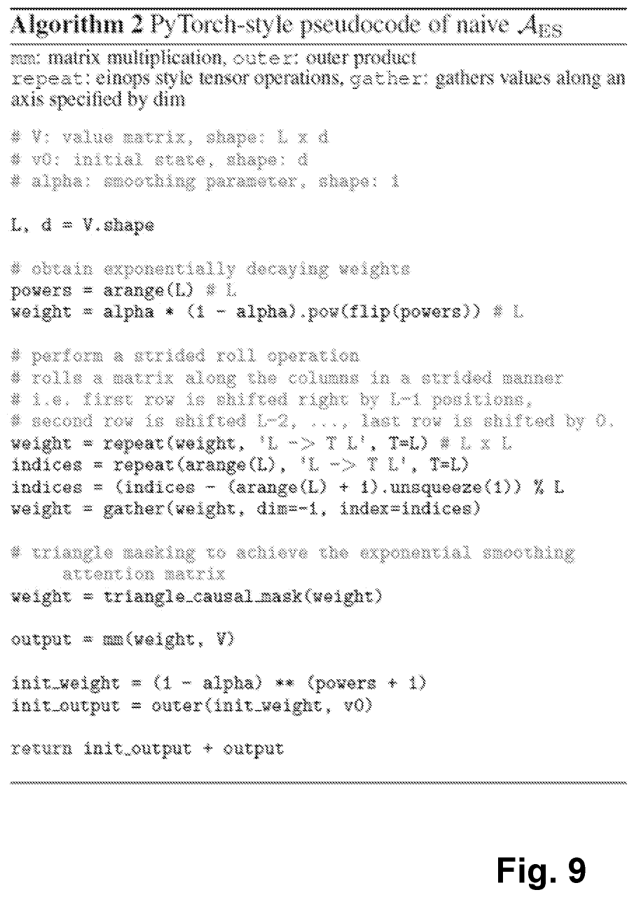

FIG. 6 is a simplified data plot diagram illustrating example time series data in the lookback window and the forecasted of the time series in a forecast horizon, according to one embodiment described herein. The ETSformer model 110 may receive data 102 (shown in FIG. 1) that includes the data in a lookback window 615. In some embodiments, the ETSformer model 110 may determine a lookback window 615 to balance the memory required for the model and the computational time required. The ETSformer model 110 may generate a time series forecast in a forecast horizon 616 based on the data 102.

In some embodiments, the ETSformer model 110 may decompose the data 102 as shown in FIG. 620 to determine a seasonal representation of the time series data 102. For example, the encoder 120 may determine the latent seasonal representation based on a frequency analysis to determine the dominant seasonal trend in the data 102.

In some embodiments, the ETSformer model 110 may determine the trend representation based on the level and growth terms. The ETSformer model 110 may determine the current level of the time-series data for the lookback window 615 and may then add a dampened growth representation to determine the trend representation, in the forecast horizon 616. The dampened growth representation tempers the forecast in the forecast horizon 616. The ETSformer model may generate a time series forecast in the forecast horizon 612 based on the level representation and the growth representation. The damped growth 621 may be used to forecast the time series more accurately in the forecast horizon 616. In an example, the time series forecast involving multiple steps may be more accurate when the damped growth 621 is used to forecast the time series.

### Computing Environment

FIG. 7 is a simplified diagram illustrating a computing device implementing the ETSformer model for generating a time series forecast, according to some embodiment described herein. As shown in FIG. 7, computing device 700 includes a processor 710 coupled to memory 720. Operation of computing device 700 is controlled by processor 710. And although computing device 700 is shown with only one processor 710, it is understood that processor 710 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 700. Computing device 700 may be implemented as a stand-alone subsystem, as a board added to a computing device, and/or as a virtual machine.

Memory 720 may be used to store software executed by computing device 700 and/or one or more data structures used during operation of computing device 700. Memory 720 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 710 and/or memory 720 may be arranged in any suitable physical arrangement. In some embodiments, processor 710 and/or memory 720 may be implemented on a same board, in a same package (e.g., system-in-package), on a same chip (e.g., system-on-chip), and/or the like. In some embodiments, processor 710 and/or memory 720 may include distributed, virtualized, and/or containerized computing resources. Consistent with such embodiments, processor 710 and/or memory 720 may be located in one or more data centers and/or cloud computing facilities.

In some examples, memory 720 may include non-transitory, tangible, machine readable media that includes executable code that when run by one or more processors (e.g., processor 710) may cause the one or more processors to perform the methods described in further detail herein. For example, as shown, memory 720 includes instructions for ETSformer module 730 that may be used to implement and/or emulate the systems and models, and/or to implement any of the methods described further herein. A trained ETSformer module 730 may receive input 740 such as an input data (e.g., time series data) via the data interface 715 and generate an output 750 which may be a time series forecast. Examples of the input data may include a comma separated file, a tab-separated file, and the like. The data interface 715 may comprise a communication interface, or a user interface. In some embodiments, the ETSformer module 720 includes an encoder 731 (e.g., similar to 120 in FIG. 1), a decoder 732 (e.g., similar to 150 in FIG. 1), an encoder layer 733 (e.g., 120a-n in FIG. 1) and a decoder layer 744 (e.g., 130a-n in FIG. 1). In one embodiment, the transformer module 730 and its submodules 731-734 may be implemented by hardware, software and/or a combination thereof.

Some examples of computing devices, such as computing device 700 may include non-transitory, tangible, machine readable media that include executable code that when run by one or more processors (e.g., processor 710) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

### Example Workflows

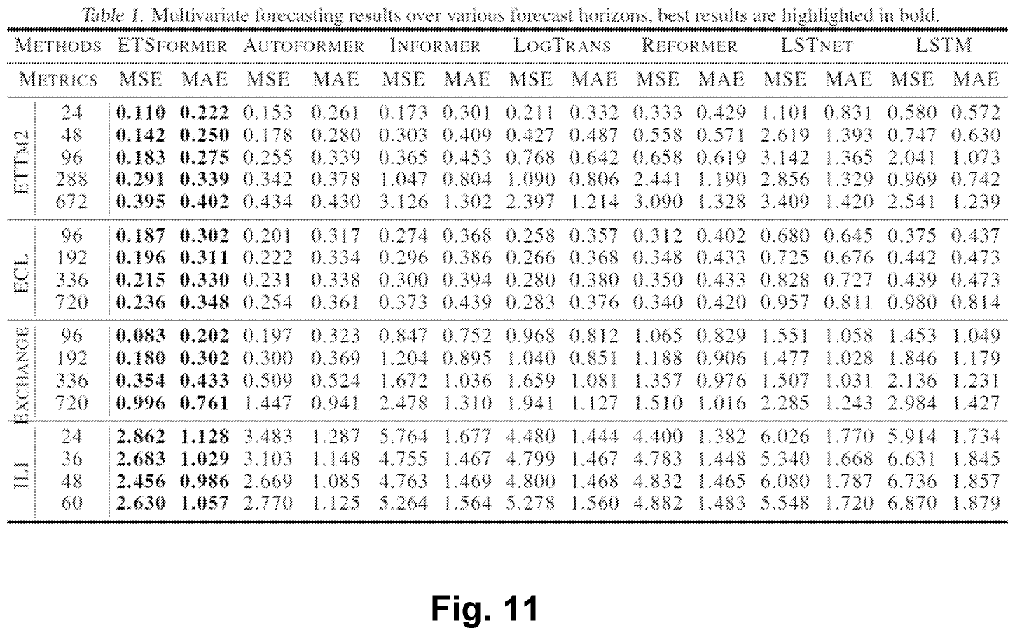

FIG. 8 is an example logic flow diagram illustrating a method of generating a time series forecast based on the ETSformer model shown in FIGS. 1-5, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the Transformer model module 730 (FIG. 7) that performs a time series forecast in a time horizon.

At step 802, a time series data (e.g., 102 in FIG. 1) is received, from a communication interface (e.g., 715 in FIG. 7). For example, the time series data such as the input (e.g., 102 in FIG. 1) may be received via a data interface (e.g., input 740 in FIG. 7.) The time series data may be in comma separated format, tab separated format, in a JSON format or the like.

At step 804, an encoder (e.g., 120 in FIG. 1) may determine a seasonal representation and a growth representation. For example, the encoder (e.g., 120 in FIG. 1) may decompose the time series data into a seasonal representation (e.g., S_{t-L:t}⁽ⁿ⁾), and a growth representation (e.g., B_{t-L:t}⁽ⁿ⁾).

At step 806, the encoder layer 120a may determining, via the frequency attention layer, the seasonal representation based on a frequency domain analysis of the time series data. Specifically, the seasonal representation encodes the seasonality of the time series data.

At step 807, the encoder layer 120a may determine via an exponential smoothing attention layer (e.g., the MH-ESA layer 220), the growth representation based on exponential smoothing of the seasonal representation. In an example, the growth representation encodes the growth of the time series data.

In some embodiments, each encoder layer 120a may encode, via a level layer (e.g., 260 in FIG. 2) the seasonal component into a level representation. The level representation may encode a de-seasonalized level of the time series data (e.g., input data 102 in FIG. 1). The level layer (e.g., 260 in FIG. 2) may determine the level representation based on the seasonal representation and a prior level value from the time series data. The time series based on the seasonal representation, the trend representation, and the level representation may be passed on to a corresponding decoder layer.

At step 810, the decoder (e.g., the decoder 130a) may determine a time series forecast in the forecast horizon based on the seasonal representation and the growth representation.

In some embodiments, the decoder (e.g., decoder 130 in FIG. 1) may determine, via a growth dampening layer, the dampened growth forecast in the forecast horizon based on the growth representation and a dampening parameter.

In some embodiments, the decoder frequency attention layer (e.g., layer connected to input 203 in FIG. 5), the seasonal forecast based on the seasonal representation. In some embodiments, the generating the time series forecast based on the dampened growth forecast, and the seasonal forecast. In some embodiments, the decoder (e.g., the decoder 130 in FIG. 1) may determine a level forecast in the forecast horizon based on a level stack, wherein the level stack stores a level of a lookback window. In some embodiments, the decoder (e.g., the decoder 130 in FIG. 1) may generate the level forecast based on the level forecast, the dampened growth forecast and the seasonal forecast.

In some embodiments, the encoder 120 comprises a plurality of encoder layers, and at least one encoder layer comprises the frequency attention layer and the exponential smoothing attention layer. In some embodiments, the pre-processing (e.g., 105 in FIG. 1), by a temporal convolutional filter, the time series data within the lookback time window into a latent space prior to feeding the time series data into the encoder.

In some embodiments, the encoder 120 may receive a residual representation of a previous frequency attention layer. The encoder 120 via the frequency attention layer (201 in FIG. 2) may decompose the residual representation based on a discrete Fourier transformation along the temporal dimension. The encoder 120 may determine the seasonal representation based on an inverse Fourier transformation of the decomposed residual representation. The decoder 120 may determine a level forecast in the forecast horizon based on a level stack, wherein the level stack stores a level of a lookback window. The decoder 130 may generate the level forecast based on the level forecast, the dampened growth forecast and the seasonal forecast. The encoder 120 comprises a plurality of encoder layers, and at least one encoder layer comprises the frequency attention layer and the exponential smoothing attention layer.

In some embodiments, the transformer model (e.g., 110 in FIG. 1) may preprocess, via a temporal convolutional filter, the time series data within the lookback time window into a latent space prior to feeding the time series data into the encoder.

The encoder (e.g., 120 in FIG. 1) may receive a residual representation of a previous frequency attention layer. The encoder may decompose the residual representation based on a discrete Fourier transformation along the temporal dimension and the encoder 120 may determine the seasonal representation based on an inverse Fourier transformation of the decomposed residual representation. The encoder 120 may determine an updated residual representation based on subtracting the seasonal representation from the residual representation.

The encoder 120 may determine, via a plurality of attention heads in the exponential smoothening layer, a latent growth representation embedded in the updated residual representation, wherein the plurality of attention heads receive as input the updated residual representations from a different look back window. The encoder 120 may determine an exponential smoothing attention matrix based on the updated residual representation.

The encoder 120 may determine the exponential smoothing average based on a cross-correlation operation on the exponential smoothing attention matrix. The encoder 120 may determine an exponential smoothing attention matrix having a lower triangular structure based on the updated residual representation. The encoder 120 may perform a convolution of a last row of the exponential smoothing attention matrix.

FIG. 9 is a simplified pseudocode segment illustrating an example operation of computing exponential smoothing attention, according to one embodiment described herein. The ESA algorithm (Alg. 2) may first construct the exponential smoothing attention matrix, AES, and then perform the full matrix-vector multiplication. Specifically, Alg. 2 may determine a value matrix based on the initial state and a shape. The encoder may obtain exponentially decaying weights based on the value matrix. The encoder may perform a strided roll operation that rolls a matrix along the columns in a strided manner. For example, the encoder may shift the first row right by L−i position, the second row by L−2 and so on until the last row is shifted by zero rows. The encoder may use a triangular mask to determine an exponential smoothing attention matrix.

FIG. 10 is a simplified pseudocode segment illustrating an alternative operation of computing exponential smoothing attention (efficient ESA) via convolution, according to one embodiment described herein. The efficient ESA algorithm (Alg. 1) relies on the convolution algorithm (Alg. 3), which may include determining a value matrix based on an initial state shape d. Alg. 1 may obtain exponentially decaying weights and computed a weighted combination. Alg. 1 may compute the contribution from a prior state, i.e., based on the residual representation. In an example, the algorithm may determine the lengths of the sequence to perform convolution.

Alg. 3 may achieve an O(L log L) complexity, by speeding up the matrix-vector multiplication. Due to the structure lower triangular structure of AES (ignoring the first column), performing a matrix-vector multiplication with it is equivalent to performing a convolution with the last row. Therefore, fast convolutions using fast Fourier transforms can be implemented through Alg. 3.

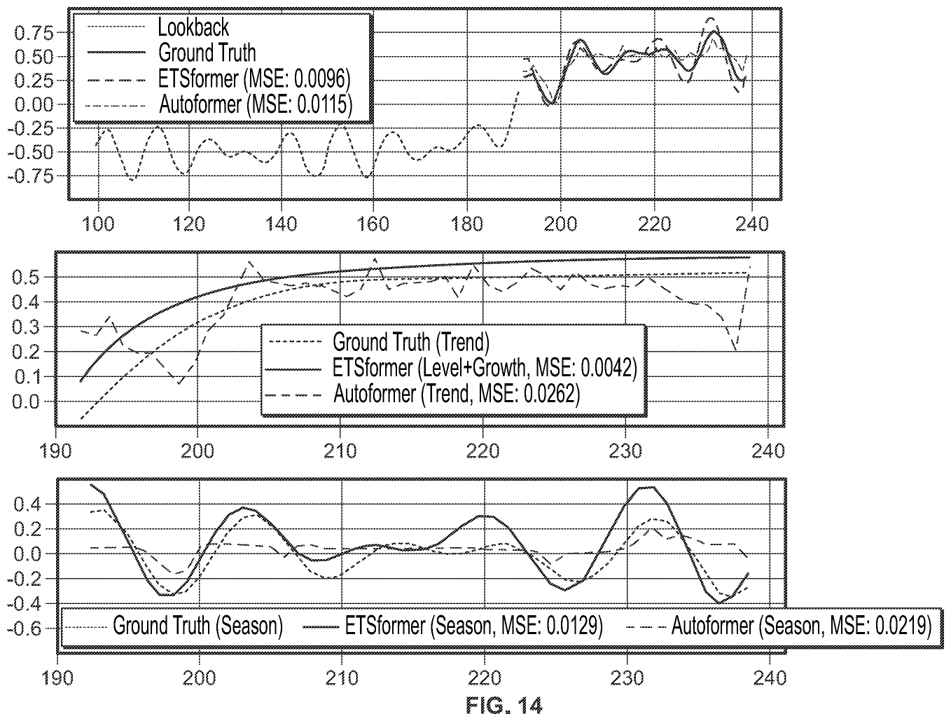

FIGS. 11-14 provide example performance from data experiments of the ETSformer model of time series forecasting described in FIGS. 1-10 (denoted as “ETSformer”), according to one embodiment described herein. In the figures, elements having the same designations have the same or similar functions. In some embodiments, the computing device (e.g., 700 in FIG. 7) may evaluate the transformer model predictions based on real world datasets from a variety of application areas. The computing device may also perform an ablation study of the various contributing components, including an analysis on the computational efficiency, and interpretability experiments of the transformer model. The computing device may split the datasets are split into train, validation, and test sets chronologically, following a 60/20/20 split for the Electricity Transformer Temperature dataset (see., Electricity Transformer Dataset available at https://github.com/zhouhaoyi/ETDataset) and 70/10/20 split for other datasets. The computing device may zero-mean normalize the inputs and MSE and MAE are used as evaluation metrics. Further implementation details can be found in Appendix C. In some embodiments, the datasets may include ETT (Electricity Transformer Temperature that includes load and oil temperature data recorded every 15 minutes from electricity transformers, the ECL (Electricity Consuming Load) measures the electricity consumption of 321 households clients, aggregated to the hourly level. (see., Electricity Consuming Load dataset available at https://archieve.ics.uci.edu/ml/datasets/ElectricityLoadDiagrams20112014) (iii) Exchange tracks the daily exchange rates of eight countries from 1990 to 2016. (see., Exchange tracks available at https://github.com/laiguokun) (iv) Traffic is an hourly dataset from the California Department of Transportation describing road occupancy rates in San Francisco Bay area freeways. (see., Department of transportation dataset available at https://pems.dot.ca.gov) (v) Weather measures 21 meteorological indicators like air temperature, humidity, etc., every 10 minutes for the year of 2020 (see., Weather dataset available at https://ww.bgc-jena.mpg.de/wetter/)(vi) ILI (Influenza-like Illness) records the ratio of patients seen with ILI and the total number of patients on a weekly basis, obtained by the Centers for Disease Control and Prevention of the United States between 2002 and 2021 (see., ILI dataset available at https://gis.cdc.gov/grasp/fluview/fluportaldashobard.html.)

In some embodiments, Table 1 and Table 2 (FIGS. 11 and 12) summarizes the results of ETSformer against top performing baselines for multivariate and univariate forecasting respectively. For the multivariate benchmark, baselines include recently proposed timeseries/efficient Transformers such as the Autoformer (see., Wu, H., Xu, J., Wang, J., and Long, M. Autoformer: Decomposition transformers with Auto-Correlation for longterm series forecasting. In Advances in Neural Information Processing Systems, 2021), Informer (see., Zhou, H., Zhang, S., Peng, J., Zhang, S., Li, J., Xiong, H., and Zhang, W. Informer: Beyond efficient transformer for long sequence time-series forecasting. In Proceedings of AAAI, 2021.), LogTrans (see., Li, S., Jin, X., Xuan, Y., Zhou, X., Chen, W., Wang, Y.-X., and Yan, X. Enhancing the locality and breaking the memory bottleneck of transformer on time series forecasting. ArXiv, abs/1907.00235, 2019.), and Reformer (see., Kitaev, N., Kaiser, L., and Levskaya, A. Reformer: The efficient transformer. In International Conference on Learning Representations, 2020. URL https://openreview.net/forum?id=rkgNKkHtvB.), and RNN variants—LSTnet (see., Lai, G., Chang, W.-C., Yang, Y., and Liu, H. Modeling long and short-term temporal patterns with deep neural networks. In The 41st International ACM SIGIR Conference on Research & Development in Information Retrieval, pp. 95-104, 2018.), and LSTM (see., Hochreiter, S. and Schmidhuber, J. Long short-term memory. Neural computation, 9(8): 1735-1780, 1997.) Competitive univariate baselines include NBEATS (see., Oreshkin, B. N., Carpov, D., Chapados, N., and Bengio, Y. N-beats: Neural basis expansion analysis for interpretable time series forecasting. In International Conference on Learning Representations, 2019.), DeepAR (see., Salinas, D., Flunkert, V., Gasthaus, J., and Januschowski, T. Deepar: Probabilistic forecasting with autoregressive recurrent networks. International Journal of Forecasting, 36(3): 1181-1191, 2020. ISSN 01692070. doi: https://doi.org/10.1016/j.ijforecast. 2019.07.001. URL https://www.sciencedirect.com/science/article/pii/s0169207019301888.), ARIMA, and Prophet (see., Taylor, S. J. and Letham, B. Forecasting at scale. The American Statistician, 72(1):37-45, 2018.).

Overall, ETSformer achieves state-of-the-art performance, achieved the best performance (based on MSE) on 22 out of 25 settings for the multivariate case, and 17 out of 23 for the univariate case. Notably, on Exchange, a dataset with no obvious periodic patterns, ETSformer demonstrates an average (over forecast horizons) improvement of 39.8% over the best performing baseline, evidencing its strong trend forecasting capabilities.

FIG. 13 provide performance charts comparing ETSformer (shown at FIGS. 13(e) and (f)) with various existing attention mechanisms. As shown in FIG. 13(a)-(c), (a) Full, (b) Sparse, and (c) Log-sparse Attentions are adaptive mechanisms, where the gray circles represent the attention weights adaptively calculated by a point-wise dot-product query, and depends on various factors including the time-series value, additional covariates (e.g., positional encodings, time features, etc.). (d) Autocorrelation attention considers sliding dot-product queries to construct attention weights for each rolled input series. The (e) Exponential Smoothing Attention (ESA) and (f) Frequency Attention (FA) are compared: ESA directly computes attention weights based on the relative time lag, without considering the input content, while FA attends to patterns which dominate with large magnitudes in the frequency domain.

FIG. 14 showcases how ETSformer generates forecasts based on a composition of interpretable time-series components. ETSformer is first trained on a synthetic dataset which contains nonlinear trend and seasonality patterns.

In some embodiments, the synthetic dataset is constructed by a combination of trend and seasonal component. Each instance in the dataset has a lookback window length of 192 and forecast horizon length of 48. The trend pattern follows a nonlinear, saturating pattern,

$$b ( t ) = \frac{1}{1 + exp {β}_{0} ( t - {β}_{1} )} ,$$

where β₀=−0.2, β₁=192. The seasonal pattern follows a complex periodic pattern formed by a sum of sinusoids. Concretely, s(t)=A₁ cos(2πf₁t)+A₂ cos(2πf₂t, where f₁= 1/10, f₂= 1/13 are the frequencies, A₁=A₂=0.15 are the amplitudes. During training phase, the embodiment uses an additional noise component by adding i.i.d. gaussian noise with 0.05 standard deviation. Finally, the i-th instance of the dataset is xᵢ=[xᵢ(1), xᵢ(2), . . . , xᵢ(192+48)], where xᵢ(t)=b(t)+s(t+i)+ϵ.

Given a lookback window (without noise), the ETSformer model visualizes the forecast, as well as decomposed trend and seasonal forecasts. For this synthetic dataset, ETSformer successfully forecasts interpretable level, trend (level+growth), and seasonal components. The level tracks the (de-seasonalized) average value of the time-series, and the trend forecast (level+growth) closely matches the nonlinear trend present in the ground truth. The seasonal forecast displays similar periodicity patterns as those in the data, while being centered at zero.

When comparing the computational efficiency of ETSformer with competing Transformer-based approaches shows that ETSformer maintains competitive efficiency with quasilinear complexity Transformers while obtaining state-of-the-art performance. Furthermore, due to the unique decoder architecture of the ETSformer which does not require output embeddings, but instead relies on the Trend Damping and Frequency Attention Modules, it is observed that ETSformer has superior efficiency as forecast horizon increases.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of forecasting time series data in a forecast horizon, the method comprising:
receiving, via a data interface, a time series data;
encoding, via an encoder comprising at least a frequency attention layer and an exponential smoothing attention layer, the time series data into a seasonal representation, and a growth representation, the encoding comprising:
determining, via the frequency attention layer, the seasonal representation based on capturing a seasonal variation in a frequency domain representation of the time series data,
determining, via the exponential smoothing attention layer, the growth representation based on exponential smoothing of the seasonal representation; and
generating, via a decoder, a time series forecast in the forecast horizon based on at least in part on the seasonal representation and the growth representation.

2. The method of claim 1, further comprising:
encoding, via the encoder further comprising a level layer, the seasonal representation into a level representation that encodes a de-seasonalized level of the time series data, the decoding comprising:
determining, via the level layer, the level representation based on the seasonal representation and a prior level value from the time series data; and
generating, via the decoder, the time series forecast based on the seasonal representation, the growth representation, and the level representation.

3. The method of claim 1, further comprising:
decoding, via the decoder comprising a growth dampening layer and a decoder frequency attention layer, the decoding comprising:
determining, via the growth dampening layer, a dampened growth forecast in the forecast horizon based on the growth representation and a dampening parameter;
determining, via the decoder frequency attention layer, a seasonal forecast based on the seasonal representation; and
generating the time series forecast based on the dampened growth forecast, and the seasonal forecast.

4. The method of claim 3, wherein the generating the time series forecast based on the dampened growth forecast, and the seasonal forecast further comprising:
determining a level forecast in the forecast horizon based on a level stack, wherein the level stack stores a level of a lookback window; and
generating the level forecast based on the level forecast, the dampened growth forecast and the seasonal forecast.

5. The method of claim 1, wherein the encoder comprises a plurality of encoder layers, and at least one encoder layer comprises the frequency attention layer and the exponential smoothing attention layer.

6. The method of claim 1, further comprising:
pre-processing, by a temporal convolutional filter, the time series data within a lookback time window into a latent space prior to feeding the time series data into the encoder.

7. The method of claim 1, wherein the determining, via the frequency attention layer, the seasonal representation comprises:
receiving a residual representation of a previous frequency attention layer;
decomposing the residual representation based on a discrete Fourier transformation along a temporal dimension; and
determining the seasonal representation based on an inverse Fourier transformation of the decomposed residual representation.

8. The method of claim 7, wherein the determining, via the exponential smoothing attention layer, the growth representation based on exponential smoothing of the seasonal representation, comprises:
determining an updated residual representation based on subtracting the seasonal representation from the residual representation; and
determining, via a plurality of attention heads in the exponential smoothening layer, a latent growth representation embedded in the updated residual representation, wherein the plurality of attention heads receive as input the updated residual representations from a different look back window.

9. The method of claim 8, wherein the determining, via the plurality of attention heads in the exponential smoothening layer, the growth representation embedded in the updated residual representation comprises:
determining an exponential smoothing attention matrix based on the updated residual representation; and
determining the exponential smoothing average based on a cross-correlation operation on the exponential smoothing attention matrix.

10. The method of claim 9, wherein determining the exponential smoothing average comprises:
determining an exponential smoothing attention matrix having a lower triangular structure based on the updated residual representation; and
performing a convolution of a last row of the exponential smoothing attention matrix.

11. A system for forecasting time series data at a forecast horizon, the system comprising:
a communication interface receiving a question that mentions a set of entities;
a memory storing a plurality of processor-executable instructions; and
a processor reading and executing the instructions from the memory to perform operations comprising:
receiving, via a data interface, a time series data;
encoding, via an encoder comprising at least a frequency attention layer and an exponential smoothing attention layer, the time series data into a seasonal representation that encodes a seasonality of the time series data, a growth representation that encodes the growth of the time series data, the encoding comprising:
determining, via the frequency attention layer, the seasonal representation based on capturing a seasonal variation in a frequency domain representation of the time series data,
determine, via the exponential smoothing attention layer, the growth representation based on exponential smoothing of the seasonal representation; and
generating, via a decoder, a time series forecast based on the seasonal representation and the growth representation.

12. The system of claim 11, further comprising:
encoding, via the encoder further comprising a level layer, the seasonal representation into a level representation, the level representation encoding a de-seasonalized level of the time series data, the decoding comprising:
determining, via the level layer, the level representation based on the seasonal representation and a prior level value from the time series data; and
generating, via the decoder, the time series forecast based on the seasonal representation, the growth representation, and the level representation.

13. The system of claim 11, wherein the operations further comprise:
decoding, via the decoder comprising a growth dampening layer and a decoder frequency attention layer, the decoding comprising:
determining, via the growth dampening layer, a dampened growth forecast in the forecast horizon based on the growth representation and a dampening parameter;
determining, via the decoder frequency attention layer, a seasonal forecast based on the seasonal representation; and
generating the time series forecast based on the dampened growth forecast, and the seasonal forecast.

14. The system of claim 13, wherein an operation of generate the time series forecast based on the dampened growth forecast, and the seasonal forecast further comprises:
determining a level forecast in the forecast horizon based on a level stack, wherein the level stack stores a level of a lookback window; and
generating the level forecast based on the level forecast, the dampened growth forecast and the seasonal forecast.

15. The system of claim 11, wherein the encoder comprises a plurality of encoder layers, and at least one encoder layer comprises the frequency attention layer and the exponential smoothing attention layer.

16. The system of claim 11, wherein the operations further comprise:
pre-processing, by a temporal convolutional filter, the time series data within a lookback time window into a latent space prior to feeding the time series data into the encoder.

17. The system of claim 11, wherein an operation of determining, via the frequency attention layer further comprises:
receiving a residual representation of a previous frequency attention layer;
decomposing the residual representation based on a discrete Fourier transformation along a temporal dimension; and
determining the seasonal representation based on an inverse Fourier transformation of the decomposed residual representation.

18. The system of claim 17, wherein an operation of determining, via the exponential smoothing attention layer, the growth representation based on exponential smoothing of the seasonal representation, further comprises:
determining an updated residual representation based on subtracting the seasonal representation from the residual representation; and
determining, via a plurality of attention heads in the exponential smoothening attention layer, a growth representation embedded in the updated residual representation, wherein the plurality of attention heads receive as input the updated residual representations from a different look back window.

19. The system of claim 18, wherein an operation of determining, via the plurality of attention heads in the exponential smoothening layer, a growth representation embedded in the updated residual representation further comprises:
determining an exponential smoothing attention matrix based on the updated residual representation; and
determining the exponential smoothing average based on a cross-correlation operation on the exponential smoothing attention matrix.

20. A processor-readable non-transitory storage medium storing a plurality of processor-executable instructions for forecasting time series data at a future time horizon, the instructions being executed by one or more processors to perform operations comprising:
receiving, via a data interface, a time series data;
encoding, via an encoder comprising at least a frequency attention layer and an exponential smoothing attention layer, the time series data into a seasonal representation that encodes a seasonality of the time series data, a growth representation that encodes the growth of the time series data, the encoding comprising:
determining, via the frequency attention layer, the seasonal representation based on capturing a seasonal variation in a frequency domain representation of the time series data,
determining, via the exponential smoothing attention layer, the growth representation based on exponential smoothing of the seasonal representation; and
generating, via a decoder, a time series forecast based on the seasonal representation and the growth representation.
